(19) United States
(12) Patent Application Publication
(10) Pub. No.: US 2007/0077058 A1
(43) Pub. Date: Apr. 5, 2007

(54) Multi-directional operation switch and switch device using the same

(76) Inventor: Masaki Kontani, Fukui (JP)

Correspondence Address: WENDEROTH, LIND & PONACK L.L.P., 2033 K. STREET, NW, SUITE 800, WASHINGTON, DC, 20006, US

(21) Appl. No.: 11/540,634

(22) Filed: Oct. 2, 2006

(30) Foreign Application Priority Data
Oct. 3, 2005 (JP) 2005-289792
Sep. 1, 2006 (JP) 2006-237226

(51) Int. Cl. G03B 19/02

(52) U.S. Cl. 396/389

(57) ABSTRACT

A multi-directional operation switch includes an operation body and plural switches. The operation body has a surface having a recess sinking in a predetermined direction. The operation body is operable to swing in a plurality of directions perpendicular to the predetermined direction. The switches are activated in response to swinging of the operation body in the plurality of directions, respectively. An operator activates this switch without operation error.

### FIELD OF THE INVENTION

The present invention relates to a multi-directional operation switch used for controlling various electronic apparatuses, and relates to a switch device using the switch.

### BACKGROUND OF THE INVENTION

A vehicle has recently had a steering switch mounted to a steering wheel. An operator, holding the steering wheel, activates the steering switch with a finger to control an electronic apparatus, such as a car audio apparatus and an automotive air conditioner. This steering switch has been demanded to be activated simply operation and have less operation errors.

FIG. 6 is a plan view of conventional switch device 5001. Pad 92 containing an air bag is provided at the center of steering wheel 1. Spoke 3 is provided between steering wheel 1 and pad 92.

Rocker switch 4 is provided on spoke 3 close to steering wheel 1. Rocker switch 4 includes operation bodies 4A and 4B which swing in left and right directions. Operation bodies 4A and 4B are arranged at upper and lower positions, respectively. Each of the operation bodies swing toward the left or right direction in response to pressing of the operation bodies. Rocker switch 4 includes plural switch contacts that establish electrical connection by the swinging of operation bodies 4A and 4B.

The switch contacts of rocker switch 4 are connected to a controller including electronic components, such as a microprocessor. The controller controls an electronic apparatus, such as a car audio apparatus and an automotive air conditioner, in response to the electrical connection of the switch contacts due to the activation of operation bodies 4A and 4B.

The operator presses the right part of the operation body 4A having a mark “+” thereon with a thumb, while holding steering wheel 1. Then operation body 4A swings and establishes the electrical connection of switch contacts under operation body 4A. The controller controls the apparatus, for example, increases a volume level of the car audio apparatus according to the electrical connection of the switch contacts.

The operator removes the thumb from operation body 4A, and then presses the left part having a mark “−” thereon. Operation body 4A swings in the reverse direction, and establishes electrical connection of switch contacts under the left part of button 4A. The controller controls the apparatus, for example, decreases the volume level of the car audio apparatus according to the electrical connection of the switch contacts.

Similarly to this, the operator pressed the right and left parts of operation body 4B to cause operation body 4B to swing, thereby allowing switch contacts under the pressed part to be connected electrically connections to the controller. The controller controls the apparatus, for example, adjusts a temperature of the air conditioner according to the electrical connection of the switch contacts.

Operation bodies 4A and 4B close to steering wheel 1 allows the operator to control the apparatus with a finger, such as a thumb), while holding steering wheel 1 with his/her hands. Thus, the operator can easily control the apparatus during driving.

In conventional switch device 5001, when the operator activate operation body 4B immediately after activating operation body 4A in the case that he/she controls the air conditioner successively to controlling the audio apparatus, the operator necessarily removes the finger from operation body 4A, visibly confirms the position of operation body 4B, and then activate the position. In this case, the operator cannot activate switch device 5001 easily, and may erroneously activate the device.

### SUMMARY OF THE INVENTION

A multi-directional operation switch includes an operation body and plural switches. The operation body has a surface having a recess sinking in a predetermined direction. The operation body is operable to swing in a plurality of directions perpendicular to the predetermined direction. The switches are activated in response to swinging of the operation body in the plurality of directions, respectively.

An operator activates this switch without operation error.

### BRIEF DESCRIPTION OF THE DRAWINGS

FIG. 1 is a perspective view of a multi-directional operation switch according to an exemplary embodiment of the present invention.

FIG. 2 is a section view of the multi-directional operation switch at line 2-2 shown in FIG. 1.

FIG. 3 is a plan view of a switch device according to the embodiment.

FIG. 4 is a section view of the multi-directional operation switch according to the embodiment.

FIG. 5 is a perspective view of another multi-directional operation switch according to the embodiment.

FIG. 6 is a plan view of a conventional switch device.

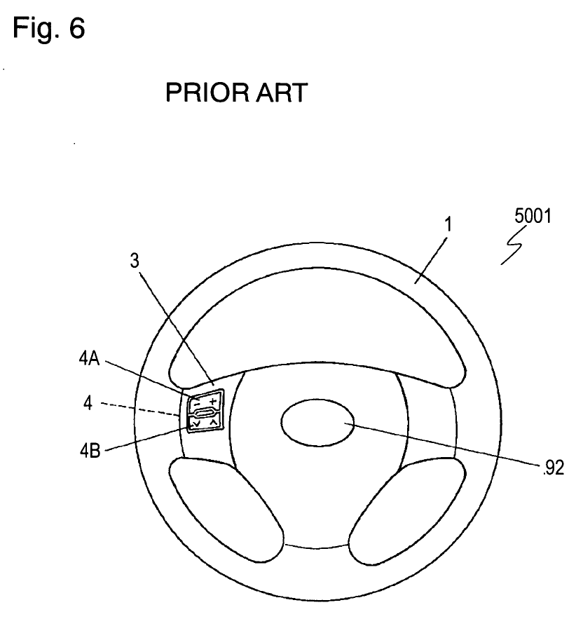

### DETAILED DESCRIPTION OF THE PREFERRED EMBODIMENT

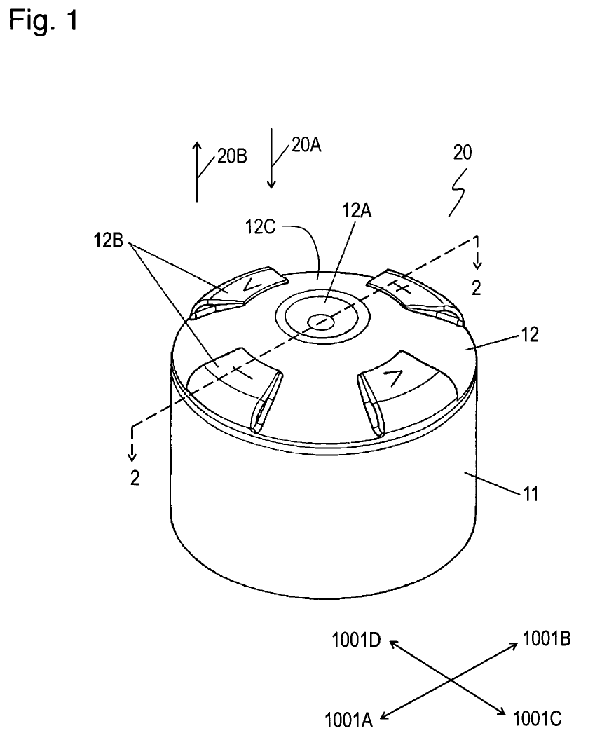

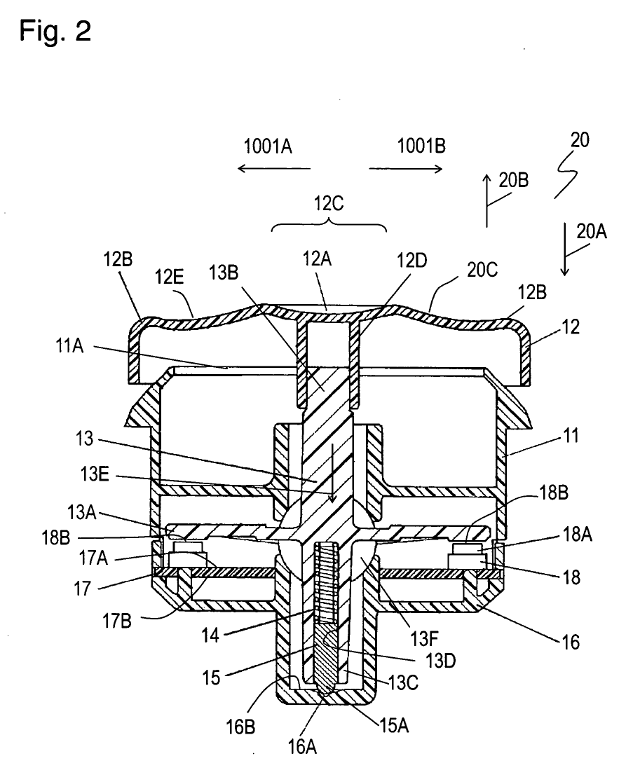

FIG. 1 is a perspective view of multi-directional operation switch 20 according to an exemplary embodiment of the present invention. FIG. 2 is a section view of multi-directional operation switch 20 at line 2-2 shown in FIG. 1. Upper case 11 having a cylindrical shape is made of insulating resin, such as ABS or polyacetal resin. Operation body 12 having a disk shape is made of insulating resin, such as ABS, acrylic, or polycarbonate. Operation body 12 covers top opening 11A of upper case 11, and swings in directions 1001A, 1001B, 1001C, and 1001D which are perpendicular to direction 20A.

The center of upper surface 12E of operation body 12 has recess 12A sinking downward, i.e. in predetermined direction 20A. Center portion 12C of operation body 12 protrudes upward, i.e., in direction 20B opposite to direction 20A like a dome. Marked portions 12B having marks, such as “+” and “−”, thereon and protruding upward from upper surface 12E are provided at end portions of operation body in directions 1001A, 1001B, 1001C, and 1001D, respectively.

An operator has a finger contact recess 12A to swing operation body 12. Recess 12A has a width or diameter ranging substantially from 5 mm to 30 mm, and has a depth ranging substantially from 1 mm to 15 mm. The width, diameter, and depth are determined according to the size of operation body 12, an operation force, or a swinging range, thereby allowing operation body 12 to be activated easily with the finger.

Lower surface 12D of operation body 12 is attached onto upper end 13B of operation shaft 13 made of insulating resin. Lower end 13C of operation shaft 13 has hole 13D therein extending in a direction in which operation shaft 13 extends. Hole 13D accommodates therein coil spring 14 and pin 15 made of insulating resin. Coil spring 14 is held while being slightly compressed to urge pin 15. Lower case 16 is fixed onto a lower surface of upper case 11. Bottom surface 16B of lower case 16 has recess 16A provided therein. Lower end 15A of pin 15 urged by spring 14 contacts recess 16A.

Middle part 13F of operation shaft 13 is held at the center of upper case 11 and lower case 16 so as to swing in directions 1001A, 1001B, 1001C, and 1001D. Arms 13A extend in these four directions from middle part 13F, respectively.

Wiring board 17 made of insulating resin has plural wiring patterns on upper surface 17A and lower surface 17B thereof. Plural push switches 18 each having push button 18A protruding are provided on upper surface 17A, providing switch contacts. Arm 13A of operation shaft 13 contacts top 18B of push button 18A. Operation body 12 swings in a direction out of directions 1001A to 1001D, thereby activating a push switch of push switches 18 corresponding to the swinging direction.

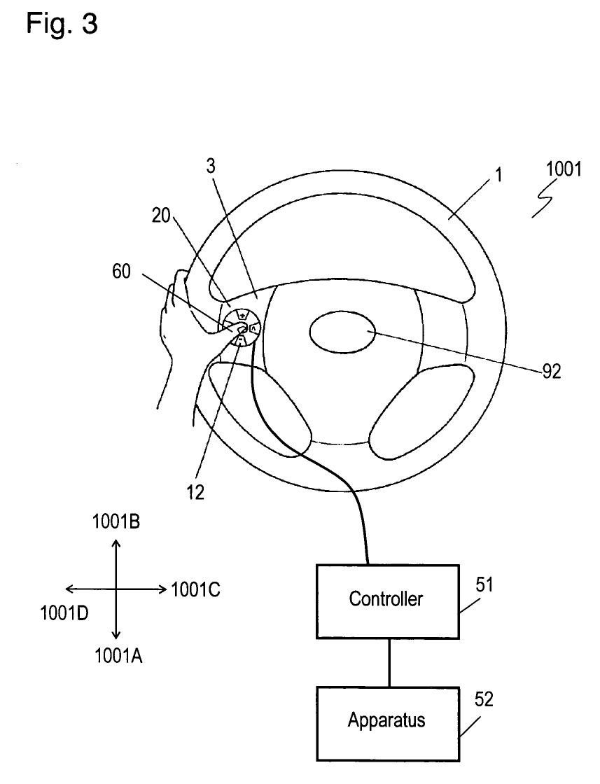

FIG. 3 is a plan view of conventional switch device 1001. Pad 92 containing an air bag is provided at the center of steering wheel 1. Spoke 3 is provided between steering wheel 1 and pad 92. Multi-directional operation switch 20 is provided in spoke 3 while operation body 12 protrudes in front at a position close to steering wheel 1.

The switch contacts of push switches 18 and the wiring patterns of wiring board 17 are connected to controller 51 including electronic components, such as a microprocessor. Controller 51 controls an apparatus, such as a car audio apparatus or an air conditioner according to the electrical connections of the switch contacts caused by the swinging of operation body 12.

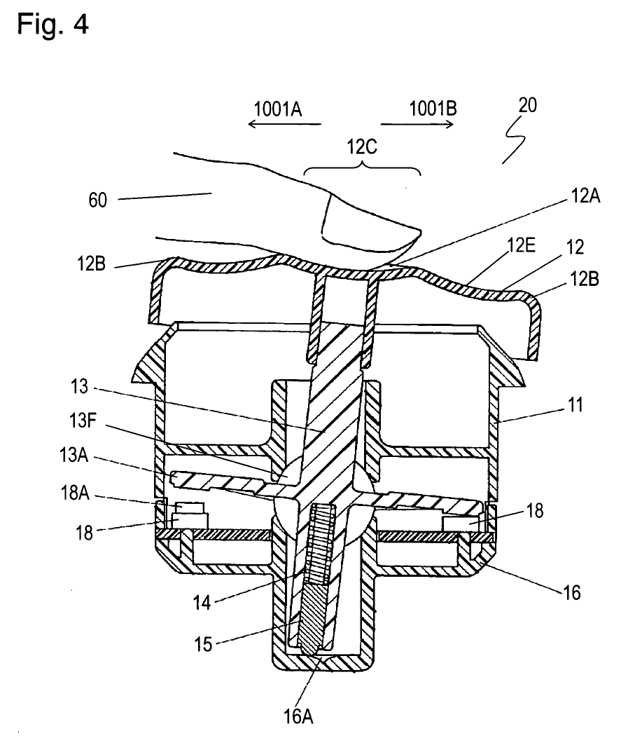

FIG. 4 shows a section view of multi-directional operation switch 20 during operation. An operator has finger 60 contact recess 12A of operation body 12 while holding steering wheel 1 by his/her hands. For example, while having finger 60 contact recess 12A, the operator applies a pressure with finger 60 to recess 12A in direction 1001B as to cause operation body 12 to swing. Then, operation shaft 13 fixed to lower surface 12D of operation body 12 accordingly swings while supported by middle part 13F as a fulcrum. Middle part 13F is held at the center of upper case 11 and lower case 16. In response to the swinging, arm 13A of operation shaft 13 extending in direction 1001B presses push button 18A to activate push switch 18, thereby establishing electrical connection of the switch contacts. Controller 51 controls apparatus 52 (FIG. 3), for example, increases a volume level of the car audio apparatus.

At this moment, according to the swinging of operation shaft 13, pin 15 urged by spring 14 comes out of recess 16A and then contacts bottom surface 16B of lower case 16, thereby generating a click feel. The click feel allows operator to notice the activation through finger 60.

While contacting recess 12A, finger 60 applies a pressure to recess 12A in direction 1001A towards marked portion 12B as to cause operation body 12 to swing in direction 1001A, thereby causing operation shaft 13 in a direction opposite to the above-mentioned direction. This operation activates push switch 18 provided in direction 1001A to establish electrical connection of the switch contacts. Controller 51 controls apparatus 52, for example, decreases the volume level of the car audio apparatus.

Similarly to this, while contacting recess 12A, finger 60 applies a pressure in directions 1001C and 1001D as to cause operation body 12 to swing, and operation shaft 13 accordingly swings as to activate push switch 18 in directions 1001C and 1001D to establish electrical connection of the switch contacts. According to the electrical connection, controller 51 controls apparatus 52, for example, adjusts a setting temperature of the air conditioner.

In switch device 1001 according to the embodiment, multi-directional operation switch 20 is provided close to steering wheel 1. The structure allows the operator to control apparatus 52 easily via the swinging operation of operation body 12 with extending, for example, only finger 60, while holding the steering wheel held by his/her hands.

The operator can cause operation body 12 to swing in directions 1001A to 1001D with finger 60 contacting recess 12A. Even in the case that push switches 18 are activated successively to one after another, the operator can easily activate switch device 1001 without visually checking a direction in which the pushing pressure is to be applied.

Even when controlling the volume level of the audio apparatus continuously, for example, increasing and decreasing the volume level, or even when controlling the air conditioner just after controlling the audio apparatus, the operator once confirms a single direction out of directions 1001A to 100D. After that, the operator can easily recognize the positional relation to activate operation body 12 in a desired direction with finger 60 contacting recess 12A. The operator can control apparatus 52 based only on the feeing at finger 60, and does not need to remove finger 60 once from operation body 12 or to confirm the position to be activated after that.

Marked portion 12B in direction 100D is not visible so much due to finger 60. However, the operator can see marked portions 12B in other direction 1001A to 1001C, and can confirm directions 1001A to 1001D visibly.

Center portion 12C of operation body 12 protrudes upward substantially like a dome, and thus, center portion 12C of operation body 12 to be contacted by finger 60 protrudes from spoke 3. This structure allows the operator to have finger 60 contact recess 12A reliably, and prevents finger 60 from removing, thereby allowing the operator to activate and cause operation body 12 to swing easily.

Operation body 12 has plural marked portions 12B at the end portions on a periphery of operation body 12, and marked portions 12B protrude from upper surface 12E. When the operator activates operation body 12 with finger 60 while holding steering wheel 1, finger 60 may slip and be removed from recess 12A. In this case, finger 60 slips on upper surface 12E and stops at marked portion 12B in an activating direction, thereby causing operation body 12 to swing in the direction.

According to the embodiment, the operator can activate and cause operation body 12 to swing in plural directions while having finger 60 contact recess 12A without removing finger 60 from operation body 12. Multi-directional operation switch 20 unnecessitates visual check in operation and provides easy operation without an operation error. Switch device 1001 including multi-directional operation switch 20 has advantages above, allowing an operator to control apparatus 52 easily.

Multi-directional operation switch 20 of the embodiment includes operation body 12 having the substantially disk shape and upper case 11 and lower case 16 having the substantially cylindrical shapes. Operation body 12, upper case 11 and lower case 16 may have other shapes, such as quadrilateral or other polygons.

Operation body 12 of the embodiment swings in four directions 1001A through 1001D, but it is not limited thereto. Operation body 12 may swing in eight or more directions. In this case, the multi-directional operation switch includes the required number of push switch 18.

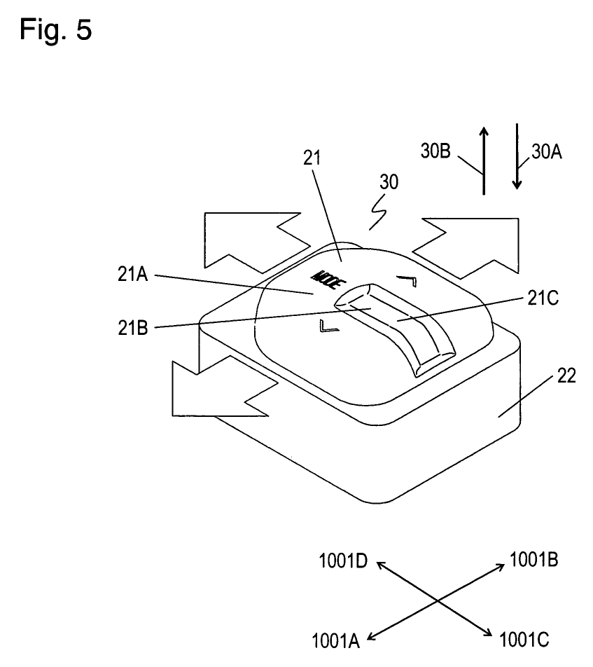

FIG. 5 is a perspective view of another multi-directional operation switch 30 according to the embodiment. Operation body 21 having a pentagon shape protrudes upward in direction 30B. Upper surface 21A has recess 21B and extending recess 21C provided therein. Recess 21B is provided in the center of upper surface 21A and sinks downward in predetermined direction 30A. Extending recess 21C extends from recess 21B in direction 1001C perpendicular to direction 30A. Symbols and letters, such as “<”, “>”, and “MODE”, are displayed in operation directions 1001B, 1001A, and 1001D on upper surface 21A.

An operator has a finger contact recess 21B and extending recess 21C extending from recess 21B so as to swing operation body 12. Each of recess 12A and extending recess 21C has a width ranging substantially from 5 mm to 30 mm, and has a depth ranging substantially from 1 mm to 15 mm. The width and depth are determined according to the size of operation body 21, an operation force, or a swinging range, thereby allowing operation body 21 to be activated easily with the finger.

An operation of multi-directional switch 30 will be described below. Similarly to multi-directional switch 20 shown in FIGS. 1 to 4, an operation shaft similar to operation shaft 13 shown in FIG. 2 is provided at a lower surface of operation body 21. Similarly to operation shaft 13, the operation shaft of switch 30 has arms extending in directions 1001A, 1001B, and 1001D at a middle part of the shaft. The shaft accommodates a pin at its lower end. The pin is urged by a spring to contact a bottom of case 22. Upon swinging in directions 1001A, 1001B, and 1001D, the arms corresponding to the directions swing to activate push switches corresponding to the directions, respectively.

Operation body 21 is not activated to swing in direction 1001C. While a finger contacts upper surface 21A, recess 21C extending in direction 1001C prevents operation body 21 from swinging in direction 1001C.

That is, in multi-directional switch 20 shown in FIG. 1, recess 12A provided in the center of operation body 12 allows operation body 12 to be activated to swing in four directions. In multi-directional switch 30, extending recess 21C which extends in an unnecessary direction, i.e., direction 1001C, allows operation body 21 to be activated to swing in other three directions 1001A, 1001B, and 1001D, and prevents operation body 21 from being activated to swing in direction 1001C.

Multi-directional switch 30 is accommodated in a spoke close to a steering wheel, so that operation body 21 faces in front at the right side or the left side of the steering wheel. An operator has a finger contact recess 21B to activate switch 30 while holding the steering wheel.

As shown in FIG. 5, operation body 21 swings in direction 1001B as to electrically connect and disconnect the push switch in case 22 corresponding to direction 1001B, accordingly, for example, increasing a volume level of an audio apparatus.

Then, while having the finger contact recess 21B, the operation causes operation body 21 to swing in direction 1001A reverse top the above direction, accordingly decreasing the volume level of the audio apparatus. Alternatively, the operator causes operation body to swing in direction 1001D inside the steering wheel, accordingly switching the mode, such as FM, AM of a radio, CD, or MD, of the audio apparatus.

Thus, recess 21C which is provided in upper surface 21A of operation body 21 and which extends in direction 1001C prevents operation body 21 from being activated in direction 1001C, i.e., a direction unnecessary to operate. When operation body 21 is activated in directions 1001A, 1001B, and 1001D which is necessary to operate the audio apparatus, the finger contacts an inclining wall of recess 21C to cause operation body to swing in the directions, thus allowing multi-directional switch 30 to be activated easily and securely.

Multi-directional operation switch 20 includes push switch 18 as switch contacts, but it is not limited thereto. Switch 18 may be a switch including a dome-shaped movable contact made of conductive metal, or a switch including a movable contact and a fixed contact facing each other between flexible upper and lower films, providing the same effects.

What is claimed is:

1. A multi-directional operation switch comprising:
an operation body having a surface, the surface having a first recess sinking in a predetermined direction, the operation body being operable to swing in a plurality of first directions perpendicular to the predetermined direction; and
a plurality of switches activated in response to swinging of the operation body in the plurality of first directions, respectively.

2. The multi-directional operation switch of claim 1,
wherein the operation body has a center portion thereof, the center portion of the operation body has a substantially dome shape protruding in a direction opposite to the predetermined direction, and
wherein the recess is provided in the center portion of the operation body.

3. The multi-directional operation switch of claim 1, wherein the surface of the operation body further has a second recess extending from the first recess in a second direction perpendicular to the predetermined direction.

4. A switch device comprising:
a steering wheel; and
a multi-directional operation switch provided at the steering wheel, the multi-directional operation switch including
an operation body having a surface, the surface having a recess sinking in a predetermined direction, the operation body being operable to swing in a plurality of directions perpendicular to the predetermined direction, and
a plurality of switches activated in response to swinging of the operation body in the plurality of directions, respectively.

5. The switch device of claim 4, further comprising a controller operable to control an apparatus according to operation of the plurality of switches.
